(19) United States
(12) Patent Application Publication
(10) Pub. No.: US 2005/0130659 A1
(43) Pub. Date: Jun. 16, 2005

(54) Method for optimizing handover between communication networks

(75) Inventors: Sandro Grech, Helsinki (FI); Pedro Serna, Malaga (ES); Govindarajan Krishnamurthi, Arlington, MA (US); Hemant M. Chaskar, Woburn, MA (US); Dirk Trossen, Cambridge, MA (US); Leopoldo Alarcon, Malaga (ES)

Correspondence Address: SQUIRE, SANDERS & DEMPSEY L.L.P., 14TH FLOOR, 8000 TOWERS CRESCENT, TYSONS CORNER, VA, 22182, US

(73) Assignee: NOKIA CORPORATION

(21) Appl. No.: 10/766,882

(22) Filed: Jan. 30, 2004

(30) Foreign Application Priority Data
Jun. 30, 2003 (GB) 0315278.2

(51) Int. Cl. H04Q 7/20

(52) U.S. Cl. 455/436; 455/442

(57) ABSTRACT

A method for ensuring continuity of a communication session when a user equipment hands over from a first communication network to a second cellular communication network is provided. The method, in one embodiment, includes the steps of performing an authentication procedure for a packet data session with the second network while still being attached to the first network and simultaneously performing a packet data session establishment procedure with the second network while still being attached to the first network.

### BACKGROUND OF THE INVENTION

1. Field of the Invention

The invention is concerned with the optimization of the handover process when a user equipment (UE), for example, a mobile node (MN), requires a seamless transfer during movement between, for example, the coverage area of a wireless local area network (WLAN) and the coverage area of a cellular communication network.

2. Description of the Related Art

Communication systems that provide users thereof with wireless communication are known. A typical example of such a system is a cellular or mobile communications system. The cellular communication system is a communication system that is based on the use of radio access entities and/or wireless service areas. The access entities are often referred to as cells. A characteristic feature of the cellular systems is that they provide mobility for the users of the communication system. Hence, they are often referred to as mobile communication systems. Another type of wireless communication system can be provided by way of a wireless local area network (WLAN). A WLAN is typically provided to allow access over a limited area such as within or in the close vicinity of a building. A WLAN network provides a low cost and high speed wireless access solution for localized “hotspots” e.g. a WLAN where only employees of the company are authorized to access the network without being charged a fee or a bookstore WLAN where customers are charged a reader fee to access the network. In contrast, cellular access in a Third Generation (3G) network area is typically always charged to a user's account with the cellular operator.

Non-limiting examples of cellular communications systems include standards such as the GSM (Global System for Mobile communications) or various GSM based systems (such as GPRS General Packet Radio Service), AMPS (American Mobile Phone System), DAMPS (Digital AMPS), WCDMA (Wideband Code Division Multiple Access), TDMA/CDMA (Time Division Multiple Access/Code Division Multiple Access) in UMTS (Universal Mobile Telecommunications System), IMT 2000, i-Phone and so on.

In a cellular system, a base transceiver station provides a wireless communication facility that serves mobile stations (MS) or similar wireless user equipment (UE) via an air or radio interface within the coverage area of the cell. As the approximate size and the shape of the cell is known, it is possible to associate the cell to a geographical area. The size and shape of the cells may vary from cell to cell. Several cells may also be grouped together to form a larger service area.

Each of the cells can be controlled by an appropriate controller apparatus. For example, in the WCDMA radio access network the base station (which may be referred to as a Node B) is connected to and controlled by the radio network controller (RNC). In the GSM radio network the base station may be connected to and controlled by a base station controller (BSC) of a base station subsystem (BSS). The BSC/RNC may be then connected to and controlled by a mobile switching center (MSC). Other controller nodes may also be provided, such as a serving GPRS support node (SGSN). The MSCs of a cellular network are typically interconnected and there may be one or more gateway nodes connecting the cellular network e.g. to a public switched telephone network (PSTN) and other telecommunication networks such as to the Internet and/or other packet switched networks.

Various types of user equipment (UE) such as computers (fixed or portable), mobile telephones, personal data assistants or organizers and so on are known to the skilled person and can be used to access the Internet to obtain services via a mobile communication system. Mobile user equipment is often referred to as a mobile station (MS) and can be defined as a means that is capable of communication via a wireless interface with another device such as a base station of a mobile telecommunication network or any other station. Each mobile user equipment can typically be identified based on a specific or unique identifier, for example, based on the International Mobile Subscriber Identity (IMSI).

The 3G Partnership Project (3GPP) defined a reference architecture for the Universal Mobile Telecommunication System (UMTS) core network which provides the users of user equipment UE with access to a wide range of services such as Internet Protocol Multimedia 1M Services, conferencing, telephony, gaming, rich call, presence, e-commerce and messaging. The UMTS core network is divided into three principal domains. These are the Circuit Switched (CS) domain, the Packet Switched (PS) domain and the Internet Protocol Multimedia (IM) domain.

The core network may be based on the user of the general packet radio service (GPRS). The GPRS operation environment includes one or more subnetwork service areas, which are interconnected by a GPRS backbone network. A subnetwork includes a number of packet data service nodes (SN), which in this application will be referred to as serving GPRS support nodes (SGSN), each of which is connected to the mobile communication access network (typically to base station systems by way of radio network controllers (RNC)) in such a way that it can provide a packet service for mobile user equipment via several base stations, i.e. cells. The intermediate mobile communication access network provides packet-switched data transmission between a support node and mobile data terminals. Different subnetworks are in turn connected to an external data network, e.g. to a packet switched public data network (PSPDN), via GPRS gateway support nodes (GGSN). An example of an external data network is an Internet Protocol (IP) network. The GPRS service thus allows packet data transmission between mobile user equipment and external data networks when the cellular network functions as an access network.

In a GPRS network the mobile user equipment may send a message requesting to activate a packet data protocol (PDP) context in the network. A serving GPRS support node (SGSN) authenticates the mobile user and sends a PDP context creation request to a GGSN selected according to a GGSN address stored in the subscriber data or according to the access point name given by the user equipment, or to a default GGSN known by the SGSN.

In such a network, a packet data protocol (PDP) context is established to carry traffic flows over the network. Each PDP context includes a radio bearer provided between the user equipment and the radio network controller. A radio access bearer is provided between the user equipment, the radio network controller and the SGSN. Switched packet data channels are provided between the serving GPRS service node (SGSN) and the gateway GPRS service node (GGSN). Each PDP context can carry more than one traffic flow, but all traffic flows within one particular PDP context are treated the same way as regards their transmission across the network. The PDP context treatment requirement is based on the PDP context treatment attributes associated with the traffic flows, for example, quality of service and/or charging attributes.

The 3G technology encompasses both WCDMA (Wideband Code Division Multiple Access) and cdma2000 (Code Division Multiple Access 2000) air interfaces. The 2.5G technology may employ GPRS (General Packet Radio System). At present, both the 3G and 2.5G technologies are proliferating and are likely to be required for some time. A complementary technology has also been introduced which is known as IEEE 802.11b (Wi-Fi or wireless fidelity) and is used in a WLAN (Wireless Local Area Network).

While UMTS networks, in particular 3G networks, are designed to support moderate bandwidth requirements under high mobility conditions, i.e. a wide coverage area, in contrast, a WLAN network is applicable to high bandwidth low mobility scenarios, i.e. a localized coverage area. With an increase in mobile terminals having mobile access interfaces, i.e. a combination of cellular and WLAN radio interfaces, end users may naturally want to be able to seamlessly transfer an ongoing Internet session between a WLAN and a UMTS network as they move between the coverage areas of these networks. Therefore, there is a concern with the optimization of the handover process in such a situation.

During a handover at IP (Internet Protocol) level between a WLAN network and a UMTS/GPRS network, the mobile terminal or MN (Mobile Node) must first achieve link layer (L2) connectivity with the UMTS RAN (Radio Access Network). In order to achieve that, the MN synchronizes with the RAN and establishes a L2 connection. After synchronization, the authentication procedure is started and the MN and the UTMS network are authenticated by each other. If the procedure is successful, the MN is authorized to access the UMTS network. As a final step, the MN gets IP connectivity by performing the PDP (Packet Data Protocol) Context Activation procedure. As a result, the MN obtains an IP address and also the UTMS network is configured with the negotiated Qos (Quality of Service) parameters for that IP session.

One prior art solution addresses the handover between a WLAN and a cdma2000 network and is concerned with minimizing the time involved in “establishing” IP bearers in the cdma2000 network. However, there is no attempt to solve the particular problem of how network layer (L3) IP bearers are established in conjunction with link layer (L2) authentication. This prior art solution describes only how the network performs L2 authentication and PDP context establishment once the MN has moved into the UMTS (3G) domain. The resulting delay in handover time means that a security association has to exist between the two networks.

In a typical scenario, a MN initiates an IP session while roaming from a WLAN network into 3G coverage. If the MN has to perform all the protocols described earlier, the time involved will cause a disruption in the IP session. Furthermore, in certain situations, depending on the local environment, the region of overlap between the signals from the WLAN and UMTS networks may not be very large. Reduced regions of overlap may occur, for example, when moving in and out of tunnels and when there is disruption due to certain types of building construction. In such a scenario, it has been found that, when the MN moves from a WLAN network to a cellular network, the WLAN signal may fade very fast and, as a result, the time frame for carrying out the handover is very small. Therefore, in such a situation, a MN must minimize the latency of the IP level handovers between the WLAN and UMTS networks to avoid the chance of a non-seamless handover arising. A seamless handover arises when the handover time is reduced (i.e., lack of IP connectivity is reduced) and when there is a very small, if any, loss of IP packet.

### SUMMARY OF THE INVENTION

According to the invention, there is provided a method for ensuring continuity of a communication session when a user equipment hands over from a first communication network to a second cellular communication network. The method includes the steps of performing an authentication procedure for a packet data session with the second network while still being attached to the first network and simultaneously performing a packet data session establishment procedure with the second network while still being attached to the first network.

According to another embodiment, there is provided a method for ensuring continuity of a communication session when a user equipment hands over from a first communication network to a second cellular communication network. Attachment of the user equipment to the second network is maintained after the user equipment moves away from the coverage area of the second network for a predetermined time in order to allow the user equipment to return to the second network without having to repeat an authentication procedure and a packet data session establishment procedure before handing over to the second network.

According to the invention, there is also provided a communication system including a user equipment, a first communication network and a second cellular communication network. The system can be arranged to enable continuity of a communication session when the user equipment moves from the coverage area of the first network to the coverage area of the second network. In one embodiment, a device is provided to simultaneously perform an authentication procedure for a packet data session with the second network and perform a packet data session establishment procedure with the second network while the user equipment is still attached to the first network.

### BRIEF DESCRIPTION OF THE DRAWINGS

FIG. 1 is a simplified presentation of a mobile communication system according to an embodiment of the invention;

FIG. 2 depicts the signal flow in the embodiment shown in FIG. 1;

FIG. 3 is a simplified presentation of a mobile communication system according to another embodiment of the invention; and,

FIG. 4 depicts the signal flow in the embodiment shown in FIG. 2.

### DETAILED DESCRIPTION OF THE PREFERRED EMBODIMENTS

As described earlier, during a handover the MN performs a number of actions each of which contribute to the total handover time. Some of the actions are, for example, MN authentication in the UMTS/GPRS network, obtaining a new IP address in the UMTS/GPRS network and even specific L2 procedures depending on the access technology the MN will use in the UMTS/GPRS network. Clearly, all of these actions take time which may result in a non-seamless transfer if performed on entry into the second network.

With the aim of performing a seamless transfer, at least some of the actions will be performed while the MN is attached to the WLAN network. Preferably, all of the actions will have been completed before the movement from the WLAN to the UMTS/GPRS network takes place.

Some contributions to the handover time when moving from the WLAN to the UMTS/GPRS are currently as follows:
1. Authentication of the MN in the target network and also authentication of the target network by the MN. Link layer authentication may be required because the target network has to establish whether the MN is allowed to access that network or not;
2. Activation of PDP contexts. If the target UMTS network is a GPRS, the activation of the PDP contexts is carried out during handover. The PDP contexts are logical connections needed inside the GPRS network for the transmission of PDUs (Packet Data Units) of upper layers (layers placed above the link layer e.g. IP) in this case IP packets between the MN and the GGSN (Gateway GPRS Support Node). The GGSN acts as an AR (Access Router) in the GPRS network from the point of view of the MN.

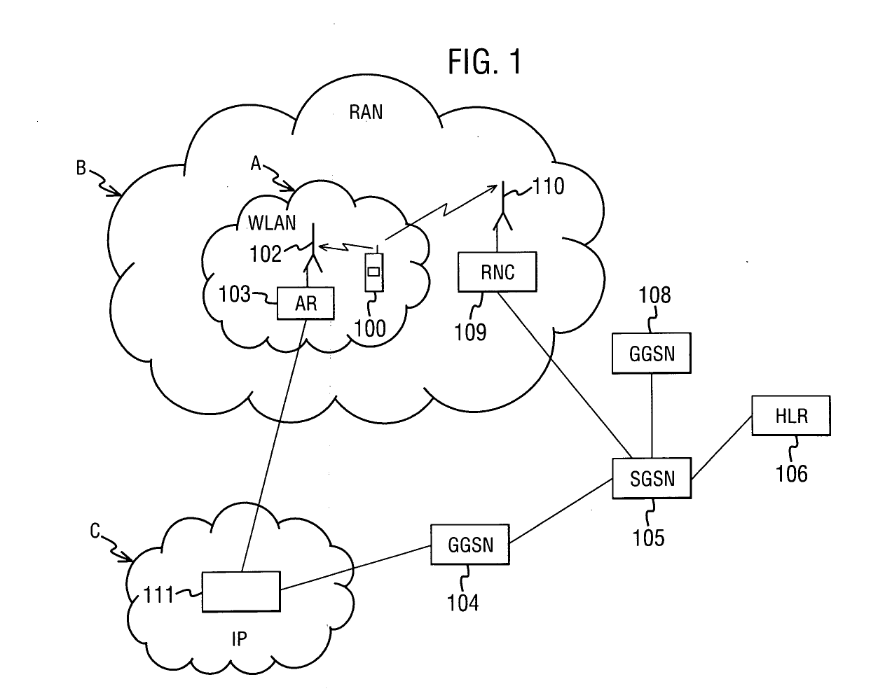

FIG. 1 illustrates a simplified presentation of a first embodiment of the invention for handover between a WLAN network A and a GPRS network B.

In this example, the mobile node (MN) 100 is engaged in an IP communication session between the WLAN network A and the IP network C. The IP communication session is provided by, for example, a service provider 111. The MN 100 wirelessly receives and transmits signals from and to base station 102. There is an access router (AR) 103 for routing the signals from the base station 102 to the IP network C. If the MN now moves towards the GPRS network B and the IP communication session is to continue, the invention proposes that handover is accomplished while the MN 100 is still attached to the WLAN network A. Although FIG. 1 depicts the WLAN network A as completely within the GPRS network B, in an alternative embodiment, there may simply be an overlap between the two coverage areas. The GPRS network B may include a gateway GPRS support node (GGSN) 104, a serving GPRS support node (SGSN) 105, the home location register (HLR) 106 and a second GGSN 108 through which the IP communication session continues with the IP network C. The SGSN 105 is connected to a radio network controller (RNC) 109 in the GPRS network B and the RNC 109 is connected to a base station (Node B) 110. Once authentication and PDP context establishment is completed, the signalling will pass from the MN 100 to and from base station 110 within the RAN of GPRS network B as the IP communication session continues with IP network C via SGSN 105 and through GGSN 104.

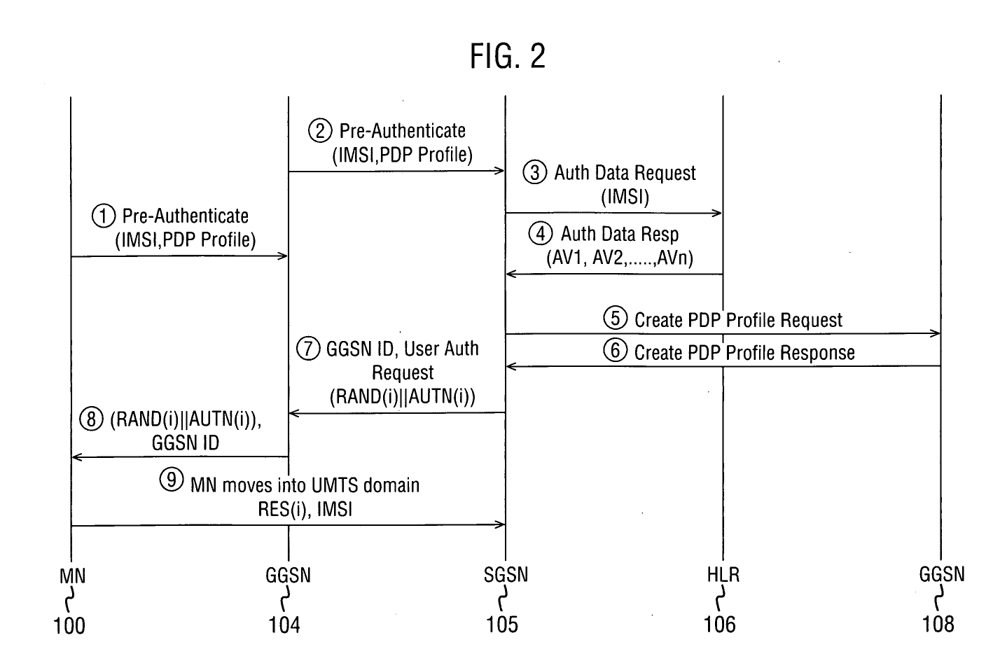

In order to access the PS (Packet Switched) service in a UMTS/GPRS network, the MN makes its presence known to the network by performing an UMTS/GPRS attach. FIG. 2 provides an example of the signal flow in the embodiment shown in FIG. 1.

In the attach request, the SGSN 105 obtains the MN's identity (IMSI—International Mobile Subscriber Identity) and an indication of which type of attach is to be executed. The SGSN 105 will then forward this information to the HLR 106 of the MN to authenticate the MN. Once authenticated at the link layer, the MN then proceeds to establish its IP bearers, also known as PDP contexts, at the GGSN 108. This process includes obtaining temporary IP addresses and establishing the QoS profile needed for its packet sessions. The GGSN 108 is chosen based on the PDP profile that the MN schedules along with the attach message.

In the invention, the information needed to authenticate the MN at the link layer and establish the PDP contexts is sent to a GGSN 104 of the target UMTS network from the MN via the access router AR 103 of the WLAN network while the MN is still connected to the AR 103. The AR 103 is located between the MN 100 and the GGSN 104 in the WLAN network and simply forwards the messages between the MN and the GGSN. Obtaining the information needed for authentication can be implemented even when the degree of overlap between the GPRS and WLAN coverage areas is negligible, albeit with less efficiency. This is enabled with help from the current AR 103 and to enable this support the AR 103 can use protocols such as CAR (Candidate Access Router) discovery. The MN is able to send the information required for link level authentication and PDP context activation to the GGSN 108 either as a separate IP packet or piggybacks the information with existing signalling for fast handover or context transfer. If the information is sent by using the fast handover procedure (i.e. the procedure used to perform a fast IP handover as described in <draft-ietf-mobileip-fast-mipv6-06.txt>), the message carrying that information would be the HI message. The context transfer procedure is another method that could be used to carry that information used to transport user's context in the IP handover (defined in <draft-ietf-seamoby-ctp-01.txt>).

The criteria that indicates to the MN that the link level authentication and the PDP context activation is to commence is, for example, decreasing signal strength or some added information provided by the WLAN network which indicates that the MN may be about to leave the WLAN network.

The information sent in the packet from the MN to the SGSN 105 may include, the IMSI of the MN, the Node B (base station 110) identifier, the QoS profile for the PDP context activation and an indication that an IP address will be needed at the target UMTS network.

The exact information contained in the PDP profile may include, for example, PDP Type, PDP Address, Access Point Name, QoS Negotiated, TEID (Tunnel Endpoint Identifier), NSAPI (Network Layer Service Access Point Identifier), MSISDN (Mobile Subscriber International ISDN Number), Selection Mode, Charging Characteristics, Trace Reference, Trace Type, Trigger ID, OMC Identity and PDP Configuration Options.

In the example shown in FIGS. 1 and 2, when the GGSN 104 receives this information from the MN 100 (step 1), it forwards the IMSI to the appropriate SGSN 105 (step 2) in its domain through the Iu interface. The correct SGSN 105 in its domain may be chosen based on the Node B 110 identifier. The GGSN 104 may maintain a mapping of SGSN 105 to Node B 110 identifiers which it consults in order to choose the correct SGSN 105. Previously, the GGSN 104 has not maintained such information which clearly would aid in reducing the time taken by link layer attach procedures. The GGSN 104 also sends the Activate PDP context message which contains the PDP profile information to the SGSN 105. Once the SGSN 105 receives the IMSI and PDP profile information, the SGSN 105 begins to authenticate the MN at the link layer (L2) and also establishes the PDP contexts, in parallel as depicted in FIG. 2 (steps 5 and 6).

The SGSN 105 sends an Authentication Data Request (IMSI) to the HLR 106 (step 3). The HLR 106 then answers with an Authentication Data Response (AV1, AV2 . . . AVn) (step 4). Step 4 also involves the sending of a session key which is derived from a secret key shared between the HLR 106 and the MN 100. The SGSN 105 then sends a User Authentication Request (RAND(i)||AUTN (i)) to the GGSN (step 7). The SGSN 105 also calculates the Expected Response (ERES (i)) and stores it along with the IMSI of the MN.

As stated earlier, the SGSN 105 establishes the link layer authentication in parallel with the requisite PDP contexts for the MN based on the information received by the GGSN 108 from the MN (step 5). This process also allows the SGSN 105 to choose the GGSN 108 in the target UTMS network which can satisfy the MN's IP required PDP profile. In the embodiment of FIG. 2, the GGSN 108 which is chosen to host the MN then informs the SGSN 105 that sends in the request about the successful establishment of PDP context (step 6). The SGSN 105 then informs the GGSN 108 in the target UTMS network that it is in communication with the WLAN network A. The AR 103 of the WLAN network A is then informed about the GGSN 108 in the target UMTS network which will host the MN. An IP address for the MN is allocated using either a stateful or a stateless means. This information is also passed on to the GGSN 104 in contact with the AR 103 of the WLAN network A to be forwarded to the MN.

According to this embodiment, when the GGSN 104 receives the authentication information, i.e. the ID of the GGSN 108 in the target network and the IP address of the MN (step 7), it packages this request and sends it to the MN (step 8) via the Internet and the AR 103 of the WLAN. This message is optionally encrypted using the session key shared between the MN and its HLR.

In the example shown in FIG. 2, when the MN receives the information provided in step 8, it decrypts the message and authenticates the network calculating the Response (RES (i)). The MN also configures its 3G interface for packet sessions with the new IP information.

When the MN moves into the UMTS domain (step 9) (or when the MN chooses to prepare for handover), it sends the RES (i) along with its IMSI information, as part of the UMTS attach, to the SGSN 105 via the associated Node B 110 which then authenticates the MN. The MN can then immediately engage in packet sessions using the configured PDP context.

When the request from the MN is received by the GGSN 108 in the target UMTS network, it may necessary to associate the Node B information with a SGSN 105 in the system. Therefore, each GGSN may store a mapping of Node Bs to SGSNs. This may be centrally controlled by the operator. Furthermore, this association mapping may generally last for a long time and sometimes will be relevant for the lifetime of the network, in which case algorithm updates may not be needed to check the consistency of the mapping.

The GGSN 104 in some cases, does not know which SGSN 105 to contact such as when the MN sends all the information for the L2 and L3 procedures except the Node B information to the WLAN AR 103. In this scenario, the AR 103 may then identify the GGSNs (3G/GPRS networks) in its neighborhood (with the help of protocols such as CAR discovery) that the MN is authorized to roam in. This embodiment, however, assumes that the CAR discovery is implemented in the AR. The AR 103 then forwards the information that the MN has sent to all the GGSNs. The GGSNs receiving the information then initiate the same procedure for authenticating the MN at the L2 layer as described previously but store the expected response from the MN at all the SGSNs in the 3G network and also establish GTP tunnels to all the SGSNs. These tunnels may have a limited lifetime or, once the MN attaches to a particular Node B and SGSN, the other tunnels may be removed. After establishing the PDP context and generating the authentication challenge as described earlier, each GGSN may send a challenge to the MN. The MN may send in turn responses to each GGSN. Once the responses are verified, separate tickets are generated with a given lifetime for each of the networks. The associated GGSNs may send back the tickets, possibly encrypted, to the MN. When the MN hears a Node B signal, it sends the appropriate ticket to that Node B and rejects the other tickets. In most practical cases, the AR will find at least one 3G/GPRS network in its neighbourhood that the MN is allowed to roam in.

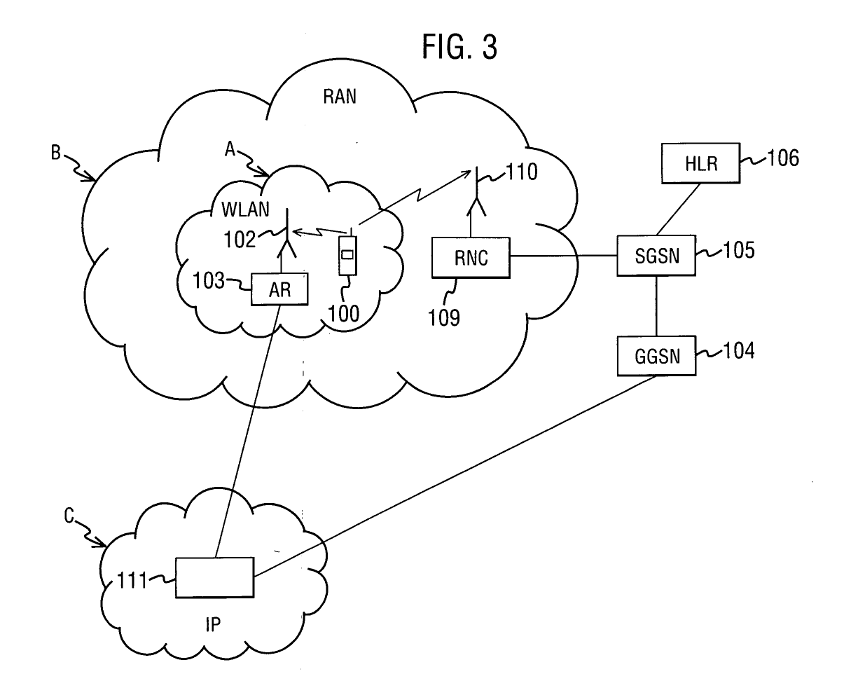

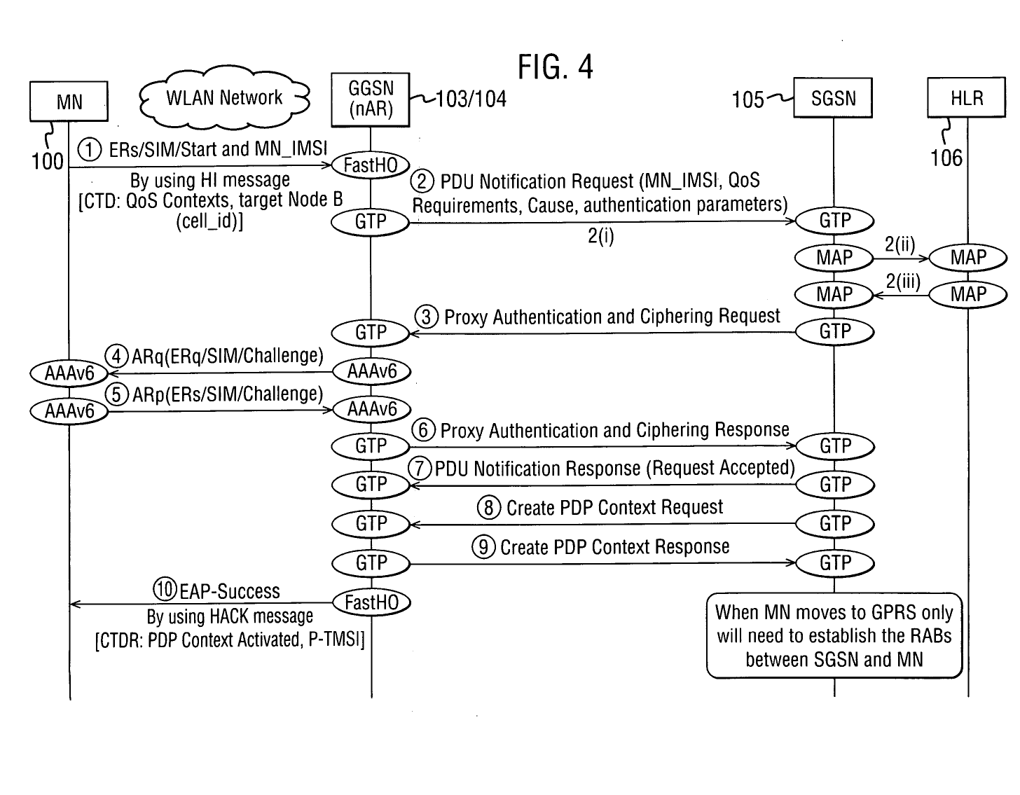

In the example shown in FIG. 2, two GGSNs 104 and 108 are present, the first GGSN 104 is in contact with the AR 103 of the WLAN network and the GGSN second 108 will host the PDP context of the MN. However, in an alternative embodiment, if the first GGSN 104 which is in contact with the WLAN network is capable of hosting the PDP context then there would be a need for only a single GGSN (as in FIGS. 3 and 4 described below).

The term “stateful” means providing the MN with an IP address has been described as involving a DHCP (Dynamic Host Configuration Protocol) server providing an IP address for the MN (this is a standard way of obtaining an IP address). However, IPv6 nodes are capable of autoconfiguring their addresses as described in RFC 2462 (see S. Thomson et al IPv6 Stateless Autoconfiguration RFC 2462 December 1998). For this purpose, the GGSN automatically and periodically sends Router Advertisement messages towards the MN after a PDP context of the type IPv6 is activated. Since in the invention the Ipv6 prefix of this GGSN may be different than that of the GGSN known to the MN, the prefix of this GGSN may also be packaged in the information sent back to the MN in order to help the MN autoconfigure its IP address while still connected to the WLAN AR.

Although the MN is described as sending a response in response to the challenge issued by the SGSN after moving into the UMTS (step 9), the response should preferably be sent via the AR of the WLAN to the GGSN before the MN decides to connect to the Node B. Namely, the network authentication by the MN and the MN authentication by the network may also be performed before connecting to the Node B. In order to complete the authentication, the GGSN may then send a “ticket” after making sure that the response is correct. The MN may then send the “ticket” to the Node B along with its IMSI. This “ticket” may be encrypted using the key shared by the MN and the HLR. The “ticket” is simply a notification from the UMTS that everything is ready and set up for the MN. The “ticket” can be encrypted to ensure that no one else can see it. Preferably, this may be established as the default means of operation of the invention. Partial authentication by using step 9 may only be used, for example, in an embodiment where the MN is unable to send a response via the WLAN AR due to being cut off prematurely before sending a response to the challenge or being cut off before getting a “ticket”.

In the method described with reference to FIGS. 1 and 2, only part of the authentication procedure (i.e. network authentication by the MN) need be performed before the movement of the MN into the UMTS network. According to one embodiment, the complete authentication procedure may be performed before the movement occurs, i.e. network authentication by the MN and MN authentication by the network.

FIGS. 3 and 4 depict a second embodiment of the invention. In this situation, the MN will be moving into the PS (packet switched) core network rather than being supposed to be attached to the PS core network (as in FIGS. 1 and 2).

In FIG. 3, a simplified presentation of the second embodiment of the invention is shown for handover between a WLAN network A as a GPRS network B. This FIG. 3 is substantially the same as FIG. 1 except that there is only a single GGSN 104 which is able to act as the AR 103 for the WLAN network A and can host the PDP contexts of the MN 100.

In FIG. 4, the SGSN 105 starts the authentication of the MN 100 by first obtaining the authentication parameters from the HLR 106 and then sending a Proxy Authentication and Ciphering Request message to the GGSN via the WLAN network. In FIGS. 3 and 4 the GGSN 104 acts as an AR 103 in the GPRS network B from the point of view of the MN and is capable of receiving a handover trigger indication from the WLAN network A. As mentioned earlier, there is a need for only one GGSN 104 in this embodiment since it is capable of hosting the PDP contexts of the MN as well as acting as an access router 103 for the WLAN network A and the GPRS network B.

In this embodiment, the following information may be carried by the handover trigger indication (Step 1 in FIG. 4):
MN's identifier i.e. MN's IMSI
MN's IP address
QoS contexts of the IP sessions already running by the MN which are to be moved from the WLAN to the GPRS network
Authentication Information, i.e. if an EAP-SIM procedure is used for authentication then the information could be the ERs/SIM/START message.

After having received the handover trigger indication, the GGSN (nAR) may send a notification to the SGSN (PDU Notification Request Message) in order to indicate that the PDP contexts for the PDP addresses should be activated. The method by which the GGSN discovers the target SGSN has been described in connection with FIG. 2 and consists of maintaining a mapping table between the possible target SGSNs and the Node Bs. Thus when the GGSN receives the handover trigger indication where there is information about the target cell where the MN is going to be located in the GPRS network, the GGSN can easily identify which is the target SGSN which will support the MN.

In this embodiment, the following information may be carried by the PDU Notification Request message (Step 2(i) in FIG. 4):
MN's identifier, i.e. MN's IMSI
The “Cause” of sending the “PDU Notification Request” message from GGSN to SGSN
QoS requirements for activation of the necessary PDP contexts in the GPRS network—The GGSN should convert the QoS contexts in the handover trigger indication into the QoS requirements to activate the PDP contexts

Authentication information if it was carried by the handover trigger indication.

The PDU Notification Request message is sent to the SGSN when the GGSN receives an external PDU (in this case, an IP message) which is targeted at a PDP address which is not yet associated to any PDP context. The purpose is to activate a PDP context for that PDP address. In this case, the transmission of that notification is also triggered when a specific external indication for handover is received at the GGSN (i.e. it is not a PDU targeted at a PDP address). The purpose is, however, the same, i.e. to create a PDP address as well as the associated PDP contexts and to perform MN authentication if the MN is not yet authenticated by the target network.

Some of the reasons for including the aforementioned parameters into the PDU Notification Request message are as follows:—

1. The “Cause” should be established so that it is clear whether the MN is supposed to be joining the PS core network or whether the MN is entering the PS core network, i.e. the values for “Cause” could be either:
a) MN entering PS core network (or incoming PDU due to MN's movement into PS core network), or
b) MN is already joining PS core network (or incoming PDU not due to MN's movement into PS core network).

If the MN is supposed to be already attached to the PS core network (“Cause” (b) above) then the SGSN performs as in FIG. 2, i.e. MN is already authenticated by the target UMTS network. If the MN is not authenticated (“Cause” (a) above) then the SGSN may start authentication as depicted in FIG. 4.

2. QoS parameters are needed to create a PDP context with the QoS requirements. This parameter is also needed if the “Cause” parameter is set to (a) MN entering PS core network.

3. Authentication parameters are needed to carry authentication information to the SGSN. These parameters are also needed if the “Cause” parameter is set to (a) MN entering PS core network.

The authentication information received in the handover trigger indication may be converted to specific GPRS authentication parameters. This may be carried out by the GGSN directly or possibly by means of the help of an AAA (Authentication Authorization Accounting) server inside the GPRS network domain.

According to the embodiment in FIG. 4, the PDU Notification Request message has been received by the SGSN (having a “Cause” value set to (a) MN entering PS core network and the MN has not been authenticated), then the SGSN may start performing the MN authentication by the target network, i.e., steps 3 to 6 in FIG. 4 (using a proxy server which is not depicted in the drawings). If the MN is already authenticated by the target network then steps 2(i), (ii) and (iii) may be followed by step 7 and the method will then be substantially the same as that described with reference to FIG. 2.

The SGSN may contact the HLR (steps 2(ii) and 2(iii) in FIG. 4) in order to obtain the MN authentication parameters. The SGSN may then send a Proxy Authentication and Ciphering Request message to the GGSN (Step 3 in FIG. 4). In this situation, the SGSN contacts the MN which is in the WLAN network through the GGSN (acting as the network Access Router) so that the authentication message is transmitted to the MN through the GGSN via the WLAN network.

When the GGSN receives the “Proxy Authentication and Ciphering Request” message, it is converted into a specific authentication protocol used by the MN (e.g. EAP-SIM) (Step 4 in FIG. 4) which is then sent to the MN.

When the MN receives the authentication message, it then replies with a further authentication message (Step 5 in FIG. 4). In this example, the messages shown are “ERq/SIM/Challenge” (Step 4) and “ERs/SIM/Challenge” (Step 5).

The GGSN will then convert the authentication message received in Step 5 into a “Proxy Authentication and Ciphering Response” message which is sent to the SGSN (Step 6 in FIG. 4). The receipt of this message by the SGSN completes the MN authentication procedure.

If the MN's authentication by the target network is successful and the SGSN can support the PDP contexts with the QoS requirement, then the SGSN replies to the PDU Notification Request message in Step 2 with a PDU Notification Response message (Step 7 in FIG. 4). This message indicates “Request Accepted”. The GGSN will then understand that the MN has been successfully authenticated and that PDP context activation will follow (Step 8 in FIG. 4).

Alternatively, if the MN's authentication procedure was successful but the SGSN cannot support the requirements of the MN, then the SGSN replies with a PDU Notification Response message indicating the cause of rejection (causes “no resources available”, “service not supported” etc may already be predefined). The GGSN then understands that the MN is successfully authenticated but the PDP context will not be activated (Step 10 in FIG. 4).

Furthermore, if the MN authentication procedure is not successful, the SGSN may reply with a PDU Notification Response message which indicates the cause of the rejection. In this case, the cause of rejection may be “MN not authenticated successfully” and step 10 may follow.

If the SGSN is able to support the PDP context required by the MN, then it sends a “Create PDP Context Request” message to the GGSN (Step 8 in FIG. 4). The GGSN may then reply with a “Create PDP Context Response” message to the SGSN (Step 9 in FIG. 4).

Since the SGSN is aware that this procedure was initiated for a MN entering the GPRS PS core network, it should finish at this point the PDP Context Activation procedure.

Finally, the GGSN replies to the message received in step 1 (“handover trigger indication”) by sending a “handover trigger response” which indicates whether the authentication procedure was successful or not. For example, in the case where EAP-SIM authentication is used then a “EAP success” message may be carried in the response and also information regarding whether the PDP context has been activated successfully or not. In addition, the attach and PDP context related parameters (e.g. P-TMSI) may be carried by this message. The WLAN network may forward these parameters to the MN. Although FIG. 4 suggests fast handover signalling is to be used, other types of signaling may be used with the same purpose.

After finishing step 10 the MN is successfully authenticated in the target GPRS network with the PDP contexts already actuated. When the WLAN network receives the “handover trigger response” from the GPRS network, the MN can be moved from the WLAN to the GPRS network.

Since the MN is the only MN which knows the key for the GPRS session (calculated within the authentication procedure), therefore, a different MN cannot supplant the legitimate MN.

During the movement the MN may only have to obtain L2 connectivity to the GPRS network (and also Iu connection the case of UTRAN/GPRS in order to establish the RABs (Radio Access Bearers). These steps are carried out by the “Service Request” procedure in the GPRS specification (defined in 3GPP TS 23.060).

Clearly, the fact that the authentication and PDP context activation procedures are not performed during handover but prior to movement from the WLAN to the GPRS network will considerably reduce handover delay times. Although FIGS. 1 to 4 relate to the handover between a first WLAN network and a second cellular network, it is clear that the invention may also be utilized in various handover scenarios where the first communication network is, for example, a different high-speed wireless technology based network. Clearly, there are many alternatives for the second cellular network rather than a GPRS, i.e. networks which employ packet switching and hence require the establishment of PDP contexts.

A third preferred embodiment of the invention provides a method whereby the PDP contexts can be maintained when the MN moves out of the GPRS network to another communication network and subsequently returns to the GPRS network.

In this embodiment, when a MN moves from a GPRS network to any other access network, e.g., a WLAN network, the MN is normally detached and the PDP contexts associated with that MN are deactivated. Accordingly, when the MN decides to return to the GPRS network, it may have to perform the attach and authentication procedures as well as the activation of the necessary PDP contexts once again.

The attach, authentication and PDP context activation procedures are time consuming. Therefore, the handover performance in an intersystem handover situation is very inefficient, particularly when the target network is GPRS. The first and second embodiments of the invention try to optimize this handover performance during an intersystem handover when the MN is detached and the PDP context deactivated in the GPRS network.

According to the third embodiment of the invention the MN remains attached to the GPRS network, i.e. the PDP contexts are maintained when the MN moves from the GPRS network to any other access network. Consequently, when the MN moves back to the GPRS network for a second time and subsequent times, it will not have to waste time performing attach, authentication and PDP context procedures so that the handover delay time can be reduced considerably.

The main disadvantage in maintaining the PDP contexts is that the PDP contexts may be considered to be invalid. This may occur if the ongoing applications running on the MN are completely different than those which the PDP contexts were originally activated for, i.e. the MN has moved from the GPRS network to another access network and has started to use different applications having other requirements before returning to the GPRS network. This may imply either a modification in the QoS requirements for the maintained PDP contexts or more drastically, the release of the maintained PDP contexts and the later activation of new PDP contexts. In both cases, the signalling generated is practically the same as the signalling generated when the maintenance of PDP contexts is not utilized.

The third embodiment of the invention can be achieved by modifying the value of a timer which already exists in the SGSN in the GPRS network. The modification will depend on the MN's multi-access capabilities.

The timer concerned is the RAU timer (Routing Area Update timer), e.g. T3312 specified by the standard 3GPP TS 24.008. The RAU timer performs the RAU procedure which is used by a roaming MN to inform the PS domain about its location in a certain area. The RAU timer is triggered when the MN goes to “PMM-IDLE” state from “PMM-CONNECTED” state (for Iu mode) or to “STANDBY” state from “READY” state (for Gb mode). Every time the timer expires, the MN may initiate the RAU procedure and the timer is reset. If the MN does not initiate the RAU procedure (this will occur when the MN abandons the GPRS network on moving to another access network), the network may automatically perform a detach and a subsequent resource release, i.e. PDP context release for that MN.

The value of the RAU timer may be given to the MN by the SGSN in the GPRS network during the attach procedure (i.e. “Attach Accept” message) and it may be assumed that the value of the timer is preconfigured in the GPRS network by the operator and that the value is the same for all of the MN's being attached to the GPRS network.

In accordance with the invention, the SGSN may allocate different values for the RAU timer depending on the multi-access capabilities supported by the MN (the SGSN is aware of the MN's capabilities as a result of the “Attach Request” message sent by the MN). If the MN is multi-access capable, then the value for the timer should be longer than the value given to a MN which is not multi-access capable. In this way, the initiation of the RAU procedure (which the MN cannot perform while using the WLAN network) will be delayed until the MN is supposed to be back in the GPRS network where the MN can perform the RAU procedure. As a result, multi-access capable MNs are able to move to any other access technology and afterwards move back to the GPRS network having maintained the attach, authentication and PDP context activation procedures.

This method is particularly pertinent to an MN which is only capable of using one radio at a time. Clearly, an MN with two radios may be able to maintain PDP contexts while simultaneously using a WLAN network. This preferred embodiment of the invention may be particularly useful in a scenario where there is temporary missing network coverage or where there are multiple GPRS networks and roaming is heavily utilized. In the case of multiple GPRS networks, one scenario may be a situation where a car in which the MN is being used travels between networks having different operators requiring constant switching between the operators.

One objective of the invention may include reducing the time for IP level handover by preparing the UTMS network for arrival of the MN both at the link layer (L2) and the IP network layer (L3) before the MN arrives at the UMTS network.

According to an embodiment, the authentication procedure includes authentication of the second network by the user equipment.

According to an embodiment, the authentication procedure also includes authentication of the user equipment by the second network.

The first communication network, according on one embodiment, may be a WLAN network and the second communication network may be a cellular network.

According to a further embodiment, the information sent by the user equipment for authentication and packet data session establishment travels either as a separate IP package or is piggybacked with existing signaling.

According to an embodiment, the gateway node between the first and second communication networks may act as an access router for the first network and may host the packet data session in the second network.

According to another embodiment, there is provided a step of releasing the packet data session if the user equipment does not handover to the second network within a predetermined time, thus requiring the user equipment to repeat the authentication procedure if moving towards the second network for a further time.

There is provided in a further embodiment a method including the following steps:
(i) the user equipment sends a handover trigger indication to a gateway node in the second network, the handover trigger indication including the user equipment identification parameters and the packet data protocol profile;
(ii) the gateway node sends the user equipment identification parameters and the packet data protocol profile to the serving node in the second network;
(iii) the serving node contacts the home location register to obtain the user equipment authentication parameters;
(iv) the serving node sends a packet data protocol profile request to the gateway node;
(v) the gateway node responds by sending a packet data protocol profile response to the serving node;
(vi) the serving node sends authentication information to the gateway node;
(vii) the gateway node sends the authentication information to the user equipment;
(viii) the user equipment authenticates the second network;
(ix) the user equipment sends a response to the serving node and moves into the second network.

There is further provided a method including the following steps:
(i) the user equipment sends a handover trigger indication to a gateway node in the second network;
(ii) the gateway node sends a protocol data unit notification request to the serving node in the second network;
(iii) the serving node contacts the home location register to obtain the user equipment authentication parameters;
(iv) the serving node sends a proxy authentication and ciphering request to the gateway node;
(v) the gateway node converts the authentication information in the request which is then sent to the user equipment;
(vi) the user equipment responds with an authentication message which is sent to the gateway node;
(vii) the gateway node converts the authentication message from the user equipment and sends a proxy authentication and ciphering response to the serving node;
(viii) the serving node sends a protocol data unit notification response to the gateway node;
(ix) the serving node sends a create packet data protocol request to the gateway node;
(x) the gateway node sends a create packet data protocol response to the serving node; and
(xi) the gateway node replies to the handover trigger indication sent by the user equipment in step (i) by sending a handover trigger response to the user equipment.

It should be noted that while the aforementioned embodiments are exemplifying embodiments of the invention, there are several variations and modifications which may be made to the disclosed solution without departing from the scope of the invention as defined herein.

1. A method for ensuring continuity of a communication session when a user equipment hands over from a first communication network to a second cellular communication network comprising the steps of:
performing an authentication procedure for a packet data session with a second communication network while still being attached to a first communication network, and
simultaneously performing a packet data session establishment procedure with the second communication network while still being attached to the first communication network.

2. A method as claimed in claim 1, wherein the step of performing the authentication procedure comprises authenticating the second communication network by a user equipment.

3. A method as claimed in claim 2, wherein the step of performing the authentication procedure comprises authenticating the user equipment by the second communication network.

4. A method as claimed in claim 1, further comprising the step of:
providing the first communication network comprising a WLAN network and the second communication network comprising a cellular network.

5. A method as claimed in claim 1, wherein the step of performing the authentication procedure comprises sending information by a user equipment for authentication and packet data session establishment, wherein the information travels either as a separate IP package or is piggybacked with existing signaling.

6. A method as claimed in claim 1, further comprising the step of:
configuring a gateway node between the first communication network and the second communication network to act as an access router for the first communication network and to host the packet data session in the second communication network.

7. A method as claimed in claim 1, further comprising the step of:
releasing a packet data session if a user equipment does not handover to the second cellular communication network within a predetermined time thus requiring the user equipment to repeat the authentication procedure if the user equipment is moving towards the second cellular communication network for a specified time.

8. A method as claimed in claim 1, further comprising the steps of:
(i) sending by a user equipment a handover trigger indication to a gateway node in the second cellular communication network, wherein the handover trigger indication comprises user equipment identification parameters and a packet data protocol profile;
(ii) sending by a gateway node the user equipment identification parameters and the packet data protocol profile to a serving node in the second cellular communication network;
(iii) contacting by the serving node a home location register to obtain user equipment authentication parameters;
(iv) sending by the serving node a packet data protocol profile request to the gateway node;
(v) responding by sending by the gateway node a packet data protocol profile response to the serving node;
(vi) sending by the serving node authentication information to the gateway node;
(vii) sending the gateway node the authentication information to the user equipment;
(viii) authenticating by the user equipment the second cellular communication network;
(ix) sending by the user equipment a response to the serving node and moving the user equipment into the second cellular communication network.

9. A method as claimed in claim 1, further comprising the steps of:
(i) sending by a user equipment a handover trigger indication to a gateway node in the second cellular communication network;
(ii) sending by the gateway node a protocol data unit notification request to a serving node in the second cellular communication network;
(iii) contacting by the serving node a home location register to obtain user equipment authentication parameters;
(iv) sending by the serving node a proxy authentication and a ciphering request to the gateway node;
(v) converting by the gateway node authentication information in the ciphering request which is then sent to the user equipment;
(vi) responding by the user equipment with an authentication message which is sent to the gateway node;
(vii) converting by the gateway node the authentication message from the user equipment and sending a proxy authentication and a ciphering response to the serving node;
(viii) sending by the serving node a protocol data unit notification response to the gateway node;
(ix) sending by the serving node a create packet data protocol request to the gateway node;
(x) sending by the gateway node a create packet data protocol response to the serving node; and
(xi) replying by the gateway node to the handover trigger indication sent by the user equipment by sending a handover trigger response to the user equipment.

10. A method for ensuring continuity of a communication session, the method comprising:
handing over by a user equipment from a first communication network to a second cellular communication network, and
when the user equipment hands over from the first communication network to the second cellular communication network, maintaining an attachment of the user equipment to the second cellular communication network after the user equipment moves away from a coverage area of the second cellular communication network for a predetermined time in order to allow the user equipment to return to the second cellular communication network without having to repeat an authentication procedure and a packet data session establishment procedure before handing over to the second network.

11. A method as claimed in claim 10, further comprising the step of:
releasing a packet data session if the user equipment does not handover to the second cellular communication network within the predetermined time thus requiring the user equipment to repeat the authentication procedure if the user equipment is moving towards the second cellular communication network for a specified time.

12. A method as claimed in claim 10, further comprising the steps of:
(i) sending by the user equipment a handover trigger indication to a gateway node in the second cellular communication network, wherein the handover trigger indication comprises user equipment identification parameters and a packet data protocol profile;
(ii) sending by a gateway node the user equipment identification parameters and the packet data protocol profile to a serving node in the second cellular communication network;
(iii) contacting by the serving node a home location register to obtain user equipment authentication parameters;
(iv) sending by the serving node a packet data protocol profile request to the gateway node;
(v) responding by sending by the gateway node a packet data protocol profile response to the serving node;
(vi) sending by the serving node authentication information to the gateway node;
(vii) sending the gateway node the authentication information to the user equipment;
(viii) authenticating by the user equipment the second cellular communication network;
(ix) sending by the user equipment a response to the serving node and moving the user equipment into the second cellular communication network.

13. A method as claimed in claim 10, further comprising the steps of:
(i) sending by the user equipment a handover trigger indication to a gateway node in the second cellular communication network;
(ii) sending by the gateway node a protocol data unit notification request to a serving node in the second cellular communication network;
(iii) contacting by the serving node a home location register to obtain user equipment authentication parameters;
(iv) sending by the serving node a proxy authentication and a ciphering request to the gateway node;
(v) converting by the gateway node authentication information in the ciphering request which is then sent to the user equipment;
(vi) responding by the user equipment with an authentication message which is sent to the gateway node;
(vii) converting by the gateway node the authentication message from the user equipment and sending a proxy authentication and a ciphering response to the serving node;
(viii) sending by the serving node a protocol data unit notification response to the gateway node;
(ix) sending by the serving node a create packet data protocol request to the gateway node;
(x) sending by the gateway node a create packet data protocol response to the serving node; and
(xi) replying by the gateway node to the handover trigger indication sent by the user equipment by sending a handover trigger response to the user equipment.

14. A communication system comprising a user equipment, a first communication network and a second cellular communication network, the system being arranged to:
enable continuity of a communication session when a user equipment moves from a coverage area of the first communication network to a coverage area of a second cellular communication network,
simultaneously perform an authentication procedure for a packet data session with the second cellular communication network and perform a packet data session establishment procedure with the second cellular communication network while the user equipment is still attached to the first communication network.

15. A communication system for ensuring continuity of a communication session when a user equipment hands over from a first communication network to a second cellular communication network, the communication system comprising:
first performing means for performing an authentication procedure for a packet data session with a second communication network while still being attached to a first communication network, and
second performing means for simultaneously performing a packet data session establishment procedure with the second communication network while still being attached to the first communication network.
